(19) United States
(12) Patent Application Publication
(10) Pub. No.: US 2015/0172557 A1
(43) Pub. Date: Jun. 18, 2015

(54) SIGNAL PROCESSING DEVICE, SIGNAL PROCESSING METHOD, AND PROGRAM

(71) Applicant: Sony Corporation, Tokyo (JP)

(72) Inventors: Akihiro Ohta, Tokyo (JP); Kei Iikawa, Tokyo (JP)

(73) Assignee: SONY CORPORATION, Tokyo (JP)

(21) Appl. No.: 14/407,105

(22) PCT Filed: Jun. 11, 2013
(86) PCT No.: PCT/JP2013/066025

§ 371 Date: Dec. 11, 2014

(30) Foreign Application Priority Data
Jun. 20, 2012 (JP) 2012-138674

(51) Int. Cl. H04N 5/262; H04N 5/38

(52) U.S. Cl. CPC H04N 5/262; H04N 5/38

(57) ABSTRACT

There is provided a signal processing device, including a partitioning section which partitions input data into a plurality of different partitioned data, and a plurality of signal processing sections which respectively process the plurality of different partitioned data. The signal processing sections each have a first processing section which performs a first data process targeting the partitioned data, and a communication section which transmits a first processing result by the first processing section to another of the signal processing sections, and receives a second processing result transmitted from another of the signal processing sections.

### TECHNICAL FIELD

The present disclosure relates to a signal processing device, a signal processing method and a program, and specifically relates to a signal processing device, a signal processing method and a program, for example, which can process input signals with a larger data amount, without enlarging a chip for signal processing.

### BACKGROUND ART

For example, in a Large Scale Integration (LSI) for image processing built into a television receiver or the like, a real-time property is achieved in which an input image input to the television receiver is processed up to a display time of this input image (for example, refer to Patent Literature 1).

While a television receiver which displays input images of 1920×1080 pixels, for example, by maintaining a real-time property, is currently the mainstream, it is anticipated that input images such as 3840×2160 pixels, 4096×2160 pixels and 7680×4320 pixels, as input images with a higher resolution, will also be adopted in the future.

Further, for example, as shown in A of FIG. 1 through to C of FIG. 1, the chip size of an LSI will increase as the pixel number of an input image to be a target of image processing increases, and it may be necessary to improve the processing capability of image processing.

That is, as shown in A of FIG. 1 and B of FIG. 1, in the case of processing an input image of 2160×3840 pixels in an LSI, it may be necessary to process a pixel number of 4 times, when compared with the case of processing an input image of 1920×1080 pixels.

In this case, it may be necessary to improve the processing capability, by setting the chip size of an LSI to a size of approximately 4 times, in order to maintain a real-time property.

Further, similarly, as shown in A of FIG. 1 and C of FIG. 1, in the case of processing an input image of 7680×4320 pixels in an LSI, it may be necessary to process a pixel number of 16 times, when compared with the case of processing an input image of 1920×1080 pixels.

In this case, it may be necessary to improve the processing capability, by setting the chip size of an LSI to a size of approximately 16 times, in order to maintain a real-time property.

### CITATION LIST

### Patent Literature

Patent Literature 1: JP 2011-180336A

### SUMMARY OF INVENTION

### Technical Problem

As described above, the necessity for using a large-sized LSI with a comparatively high price will occur as the resolution of an input image increases.

Accordingly, in the case of manufacturing a television receiver in which such an LSI is built-in, the manufacturing cost of the television receiver will increase, and it may be necessary for a large space to be secured within the television receiver in order for a large-sized LSI to be built-in, and this is not realistic.

The present disclosure is performed by considering such a situation, and can process input signals with a larger data amount, without enlarging a chip for signal processing.

According to an aspect of the present disclosure, there is provided a signal processing device, including a partitioning section which partitions input data into a plurality of different partitioned data, and a plurality of signal processing sections which respectively process the plurality of different partitioned data. The signal processing sections each have a first processing section which performs a first data process targeting the partitioned data, and a communication section which transmits a first processing result by the first processing section to another of the signal processing sections, and receives a second processing result transmitted from another of the signal processing sections.

The signal processing sections each may additionally have an acquisition section which acquires a third processing result obtained at a time when applying the first data process to the input data based on the first processing result and the second processing result, and a second processing section which performs a second data process different to the first data process, the second data process targeting the third processing result acquired by the acquisition section.

The communication section may also transmit, to another of the signal processing sections, setting information showing setting contents to be reflected in the plurality of signal processing sections in addition to the first processing result.

The communication section may cause a timing at which setting contents are reflected based on the setting information to be synchronized with another of the signal processing sections which has received the setting information.

The communication section may transmit the first processing result, along with the second processing result received from another of the signal processing sections, to an additional another of the signal processing sections.

The partitioning section may partition an input image input as the input data into a plurality of different partial images. In each of the signal processing sections, the first processing section may perform the first data process which calculates sub-region information, which is information related to a luminance of sub-regions obtained by dividing the partial images, targeting the partial images, the communication section may transmit first sub-region information obtained as a processing result of the first processing section to another of the signal processing sections, and may receive calculated second sub-region information targeting another of the partial images from another of the signal processing sections, the acquisition section may acquire the first sub-region information calculated by the first processing section and the second sub-region information received by the communication section as third sub-region information obtained at the time when applying the first data process to the input image, and the second processing section may perform the second process which performs lighting for a display of the partial images, and generates backlight data for controlling a part of a backlight, targeting the third sub-region information acquired by the acquisition section.

According to an aspect of the present disclosure, there is provided a signal processing method of a signal processing device including a partitioning section and a plurality of signal processing sections, the method including, by the partitioning section, a partitioning step which partitions input data into a plurality of different partitioned data, and, by each of the signal processing sections, a first processing step which performs a first data process targeting the partitioned data, and a communication step which transmits a first processing result by the first processing step to another of the signal processing sections, and receives a second processing result transmitted from another of the signal processing sections, the partitioning step being performed by the partitioning section, the first processing step and the communication step being performed by each of the signal processing sections.

According to an aspect of the present disclosure, there is provided a program for causing a computer to function as a partitioning section which partitions input data into a plurality of different partitioned data, and a plurality of signal processing sections which respectively process the plurality of different partitioned data. The signal processing sections each have a first processing section which performs a first data process targeting the partitioned data, and a communication section which transmits a first processing result by the first processing section to another of the signal processing sections, and receives a second processing result transmitted from another of the signal processing sections.

According to the present disclosure, input data is partitioned into a plurality of different partitioned data, a first data process is performed targeting the partitioned data, these processing results are transmitted to another of the signal processing sections, and processing results transmitted from another of the signal processing sections are received.

### Advantageous Effects of Invention

According to the present disclosure, it becomes possible to process input signals with a larger data amount, without enlarging a chip for signal processing.

### BRIEF DESCRIPTION OF DRAWINGS

FIG. 1 is a figure which shows an example in which the chip size of an LSI is enlarged in accordance with a data amount of a processing target.

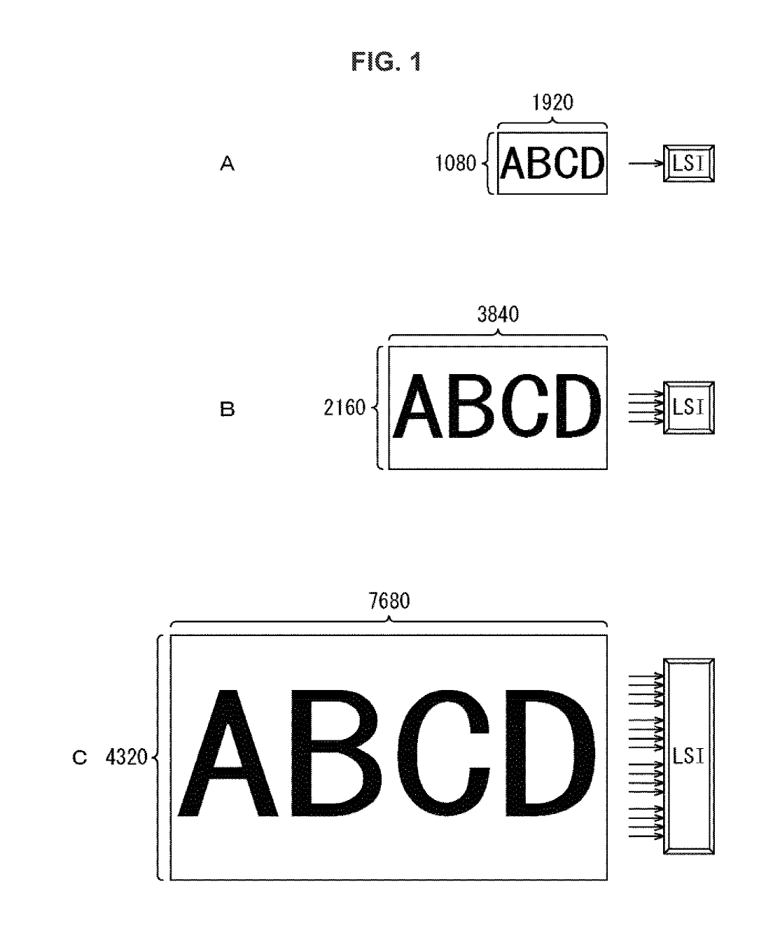

FIG. 2 is a block diagram which shows a configuration example of a television receiver in the present disclosure.

FIG. 3 is a first figure for describing the reasons for including a plurality of LSI.

FIG. 4 is a second figure for describing the reasons for including a plurality of LSI.

FIG. 5 is a block diagram which shows an example at the time when including 2 LSI.

FIG. 6 is a block diagram which shows a detailed configuration example of 2 LSI.

FIG. 7 is a block diagram which shows a detailed configuration example of the block statistic section of FIG. 6.

FIG. 8 is a figure which shows an example of the timing of processes performed by the block statistic section of FIG. 6.

FIG. 9 is a flow chart for describing a partial drive process performed by the television receiver.

FIG. 10 is a flow chart for describing the details of the block statistic process in step S22 of FIG. 9.

FIG. 11 is a figure which shows an example at the time when a microcomputer changes the states of registers of the LSI.

FIG. 12 is a figure which shows an example at the time when changing the states of registers by using communication performed between the LSI.

FIG. 13 is a block diagram which shows an example at the time when including 4 LSI.

FIG. 14 is a figure which shows an example of the timing of processes performed by the LSI of FIG. 13.

FIG. 15 is a block diagram which shows a configuration example of hardware of a computer.

### DESCRIPTION OF EMBODIMENTS

Hereinafter, an embodiment (hereinafter, called the present embodiment) in the present disclosure will be described. Note that, a description will be made in the following order.

1. The present embodiment (an example of a television receiver including a plurality of LSI)

2. Modified example

### 1. THE PRESENT EMBODIMENT

### (Configuration Example of the Television Receiver 21)

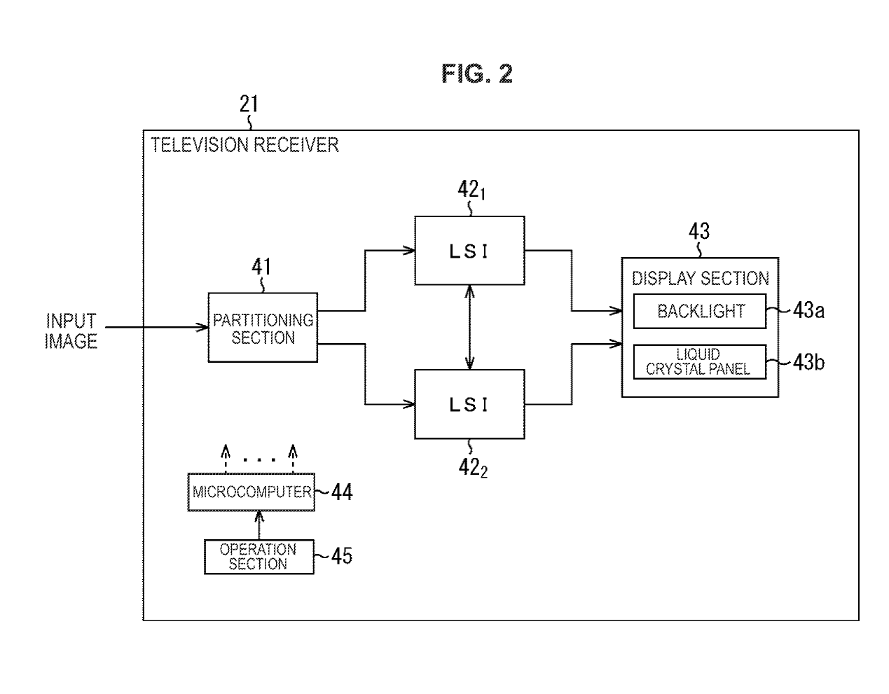

FIG. 2 shows a configuration example of a television receiver 21 which is the present embodiment.

This television receiver 21 is constituted from a partitioning section 41, Large Scale Integrations (LSI) 42₁ and 42₂, a display section 43 having a backlight 43a and a liquid crystal panel 43b, a microcomputer (hereinafter, called a microcomputer) 44, and an operation section 45.

Note that, in the television receiver 21, for example, a Field Programmable Gate Array (FPGA) or the like can be used as the LSI 42₁. This is also the same for the LSI 42₂.

Further, in the television receiver 21, image signals as content received from an antenna or the like, which is not shown, or image signals from a reproduction apparatus or the like, which is not shown, are supplied to the partitioning section 41.

The partitioning section 41 partitions the supplied image signals into a plurality of partial signals. That is, for example, the partitioning section 41 partitions an input image represented by the supplied image signals into a half image R representing the ½ region of the right side of the input image, and a half image L representing the ½ region of the left side of the input image.

Note that, in the present embodiment, while the partitioning section 41 partitions an input image into the half image R and the half image R each of a same size, it may be partitioned into the half image R and the half image L of different sizes.

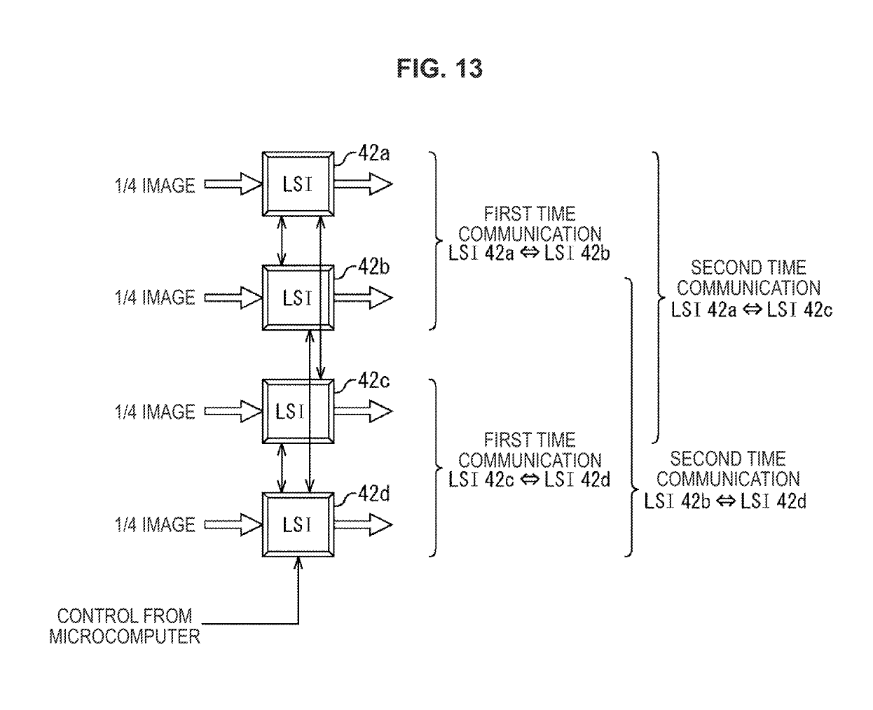

Further, while the partitioning section 41 partitions an input image into the half image R and the half image L as two partial images, it may be partitioned into three or more partial images. For example, the case where an input image is partitioned into 4 ¼ images, as partial images, will be described with reference to FIG. 13.

Then, the partitioning section 41 supplies the half image R obtained by partitioning to the LSI 42₁, and supplies the half image L obtained by the same partitioning to the LSI 42₂.

The LSI 42₁ calculates sub-region information S(r) for each sub-region r constituting the half image R, based on the half image R from the partitioning section 41, and transmits it to the LSI 42₂.

Here, sub-region information S(r) is information related to a luminance of each pixel constituting a sub-region r, and represents information, for example, which includes a maximum luminance, average luminance, distribution of luminance (for example, a histogram of luminance), a center of gravity of luminance or the like of each pixel constituting a sub-region r.

Further, the LSI 42₁ receives sub-region information S(l) from the LSI 42₂, and generates backlight data and liquid crystal signals for the half image R, based on the received sub-region information S(l) and the calculated sub-region information S(r).

Then, the LSI 42₁ performs a control of the backlight 43a necessary for outputting the half image R, by supplying the generated backlight data for the half image R to the backlight 43a.

Further, the LSI 42₁ performs a control of the liquid crystal panel 43b necessary for outputting the half image R, by supplying the generated liquid crystal signals for the half image R to the liquid crystal panel 43b.

The LSI 42₂ calculates sub-region information S(l) for each sub-region l constituting the half image L, based on the half image L from the partitioning section 41, and transmits it to the LSI 42₁.

Further, the LSI 42₂ receives sub-region information S(r) from the LSI 42₁, and generates backlight data and liquid crystal signals for the half image L, based on the received sub-region information S(r) and the calculated sub-region information S(l).

Then, the LSI 42₂ performs a control of the backlight 43a necessary for outputting the half image L, by supplying the generated backlight data for the half image L to the backlight 43a.

Further, the LSI 42₂ performs a control of the liquid crystal panel 43b necessary for outputting the half image L, by supplying the generated liquid crystal signals for the half image L to the liquid crystal panel 43b.

The display section 43 has the backlight 43a and the liquid crystal panel 43b.

For example, the backlight 43a is constituted from a plurality of Light Emitting Diodes (LED), and is turned on or turned off in accordance with controls from the LSI 42₁ and the LSI 42₂.

That is, for example, from among the plurality of LEDs constituting the backlight 43a, the LEDs turned on when outputting the half image R are turned on in accordance with a control from the LSI 42₁, and the LEDs turned on when outputting the half image L are turned on in accordance with a control from the LSI 42₂.

The liquid crystal panel 43b changes the transmissivity at which light is transmitted from the backlight 43a, in accordance with controls from the LSI 42₁ and the LSI 42₂.

That is, for example, in the liquid crystal panel 43b, the transmissivity of liquid crystals changing when outputting the half image R is changed in accordance with a control from the LSI 42₁, and the transmissivity of liquid crystals changing when outputting the half image L is changed in accordance with a control from the LSI 42₂.

Then, the liquid crystal panel 43b outputs light as an input image constituted from the half image R and the half image L, by causing light to be transmitted from the backlight 43a, with the transmissivity after being changed.

For example, the microcomputer 44 controls the partitioning section 41, the LSI 42₁, the LSI 42₂ or the like, based on operation signals from the operation section 45.

That is, for example, the microcomputer 44 causes settings or the like of respective registers to change, by controlling the LSI 42₁ and the LSI 42₂.

Here, for example, the register of the LSI 42₁ represents parameters for setting the operation state of the LSI 42₁.

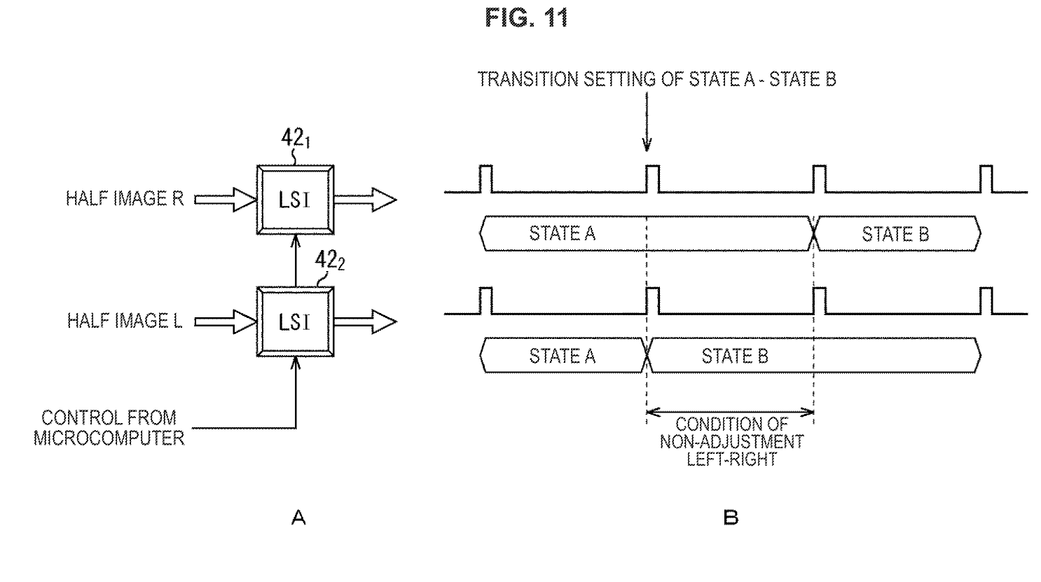

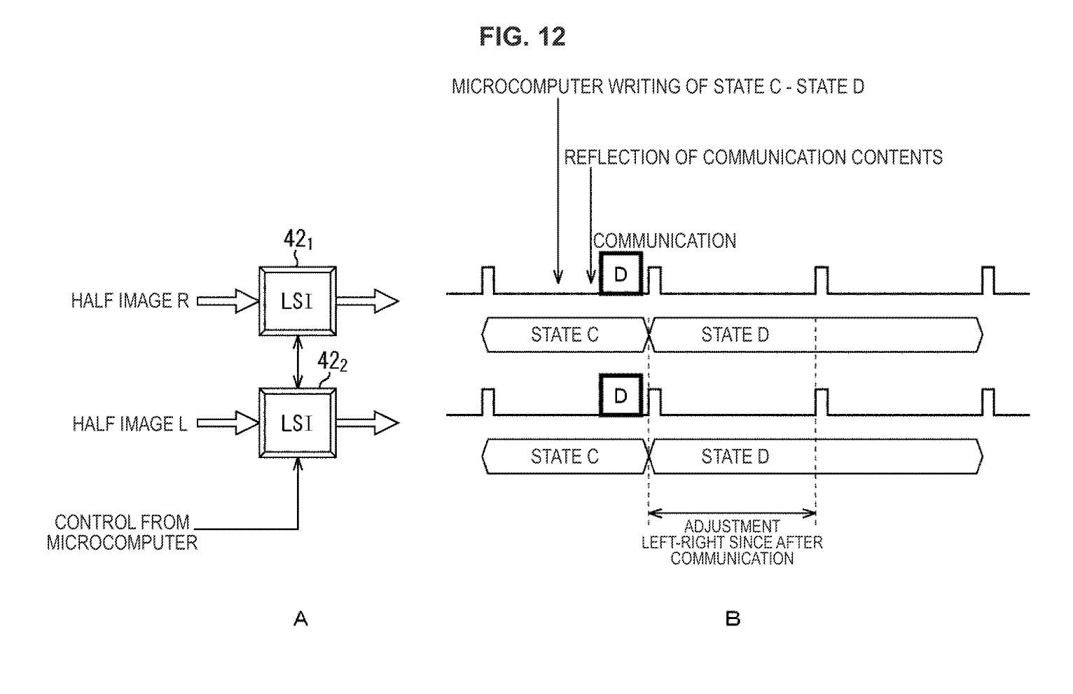

Note that, changes of the registers performed by the microcomputer 44 will be described in detail with reference to FIG. 11 and FIG. 12.

The operation section 45 is an operation button or the like operated by a user, and in accordance with an operation of a user, supplies operation signals corresponding to the operation of the user to the microcomputer 44.

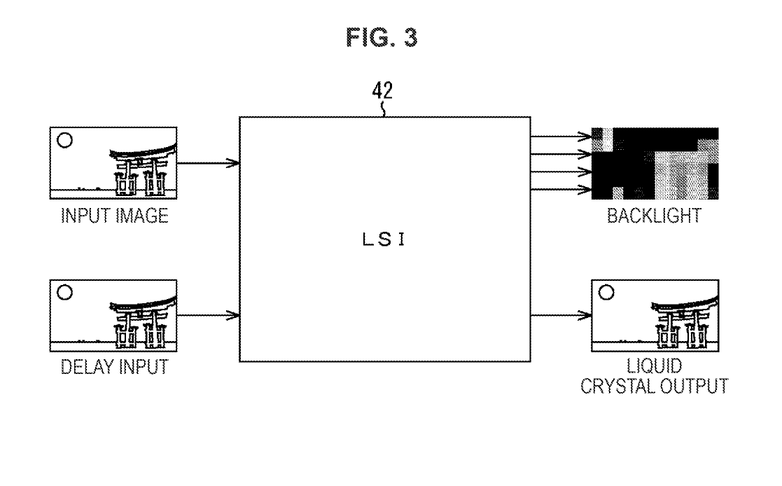

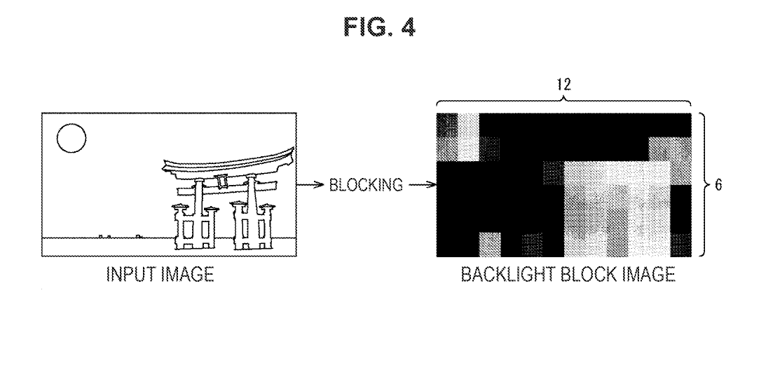

Next, the reasons for including the 2 LSI 42₁ and LSI 42₂, for example, as a plurality of LSI, and not 1 LSI, in the television receiver 21 will be described with reference to FIG. 3 and FIG. 4.

FIG. 3 shows an example at the time when the 1 LSI 42 controls the backlight 43a and the liquid crystal panel 43b.

For example, the case will be considered in which the 1 LSI 42, and not the 2 LSI 42₁ and LSI 42₂, is included in the television receiver 21.

In this case, as shown in FIG. 4, the LSI 42 performs blocking which divides an input image input to the television receiver 21 into 72 sub-regions, for example, in which horizontal×vertical is 12×6.

Further, the LSI 42 calculates respective sub-region information S(r) and S(l) from the 72 sub-regions obtained by blocking.

Then, the LSI 42 generates backlight data for the input image and liquid crystal signals for the input image, based on the calculated sub-region information S(r) and S(l).

Here, in the case where the size (data amount) of an input image is comparatively large, the necessity of a large amount of processing time for calculating the sub-region information S(r) and S(l) may occur due to the processing capability of the LSI 42, and a real-time property of the television receiver 21 will not be able to be maintained.

Accordingly, for example, by including the 2 LSI 42₁ and LSI 42₂ in the television receiver 21, the backlight 43a and the liquid crystal panel 43b can be promptly controlled, even in the case where the size of an input image is comparatively large.

Accordingly, the television receiver 21 can maintain a real-time property of the television receiver 21, while using a comparatively small-sized LSI 42₁ and LSI 42₂.

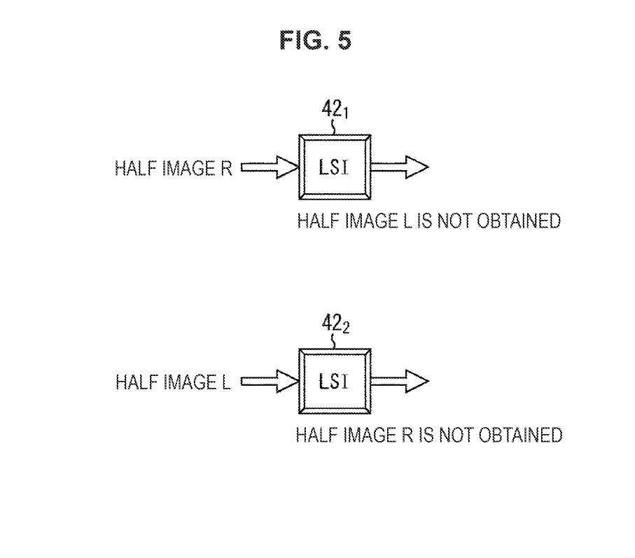

Next, FIG. 5 shows an example at the time when including the 2 LSI 42₁ and LSI 42₂.

As shown in FIG. 5, in the case where the 2 LSI 42₁ and LSI 42₂ are included in the television receiver 21, a process which calculates sub-region information S(r) and S(l) from an input image can be distributed by the LSI 42₁ and the LSI 42₂.

That is, for example, from among the half images R and L constituting an input image, the half image R is supplied to the LSI 42₁, and the half image L is supplied to the LSI 42₂.

Then, the LSI 42₁ calculates sub-region information S(r) from the supplied half image R, and the LSI 42₂ calculates sub-region information S(l) from the supplied half image L.

Accordingly, for example, sub-region information S(r) and S(l) can be calculated more promptly, when compared to the case where the 1 LSI 42 calculates sub-region information S(r) and S(l) from an input image.

However, only the half image R is supplied, and the half image L is not supplied, to the LSI 42₁. Accordingly, as shown in the upper side of FIG. 5, the LSI 42₁ is not able to acquire sub-region information S(l) calculated from the half image L.

Further, similarly, only the half image L is supplied, and the half image R is not supplied, to the LSI 42₂. Accordingly, as shown in the lower side of FIG. 5, the LSI 42₁₂ is not able to acquire sub-region information S(r) calculated from the half image R.

In the case where the LSI 42₁ generates backlight data for the half image R, sub-region information S(l) calculated from the half image L may also be necessary, in addition to sub-region information S(r) calculated from the half image R.

Since light is dispersed and output from each LED constituting the backlight 43a, it may be necessary for this to generate backlight data by also considering the dispersion of this light.

That is, from among the plurality of LEDs constituting the backlight 43a, it may be necessary for the LSI 42₁ to generate backlight data for the half image R, by also considering the LEDs which are turned on for the half image L, in addition to the LEDs which are turn on for the half image R. This is the same for the case in which the LSI 42₁ generates liquid crystal signals for the half image R.

Further, similarly, in the case where the LSI 42₂ generates backlight data for the half image L, sub-region information S(r) calculated from the half image R may also be necessary, in addition to sub-region information S(l) calculated from the half image L.

Accordingly, the LSI 42₁ and the LSI 42₂ acquire sub-region information which is not able to be calculated by themselves, by mutually transmitting and receiving respectively calculated sub-region information.

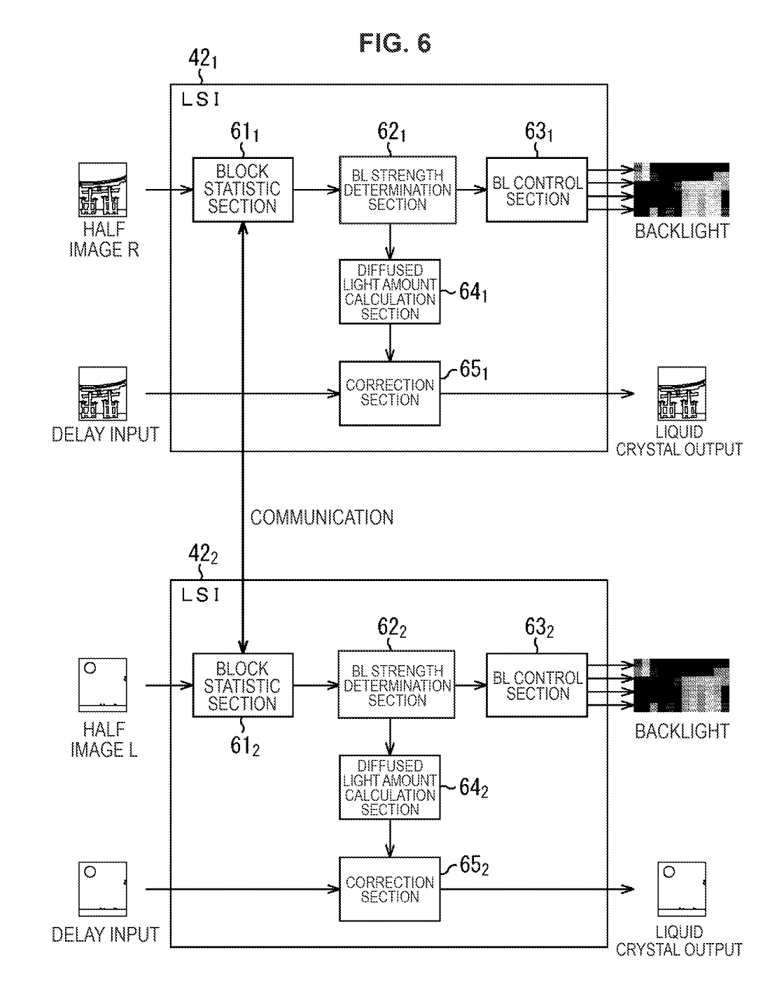

Next, FIG. 6 shows a detailed configuration example of the LSI 42₁ and the LSI 42₂ which mutually transmit and receive calculated sub-region information.

The LSI 42₁ is constituted from a block statistic section 61₁, a BL strength determination section 62₁, a BL control section 63₁, a diffused light amount calculation section 64₁, and a correction section 65₁.

Further, similarly to LSI 42₁, the LSI 42₂ is constituted from a block statistic section 61₂, a BL strength determination section 62₂, a BL control section 63₂, a diffused light amount calculation section 64₂, and a correction section 65₂.

Note that, hereinafter, in the case where it is not necessary to respectively differentiate the block statistic section 61₁ through to the correction section 65₁ of the LSI 42₁ and the block statistic section 61₂ through to the correction section 65₂ of the LSI 42₂, they will simply be called a block statistic section 61 through to a correction section 65.

Half images from the partitioning section 41 are supplied to the block statistic section 61. The block statistic section 61 calculates respective sub-region information from each of the sub-regions constituting the half images from the partitioning section 41.

Then, the block statistic section 61 acquires all of the sub-region information calculated from an input image, by mutually transmitting and receiving the calculated sub-region information.

That is, for example, the block statistic section 61₁ transmits the calculated sub-region information S(r) to the block statistic section 61₂, and receives the sub-region information S(l) transmitted from the block statistic section 61₂.

Further, for example, the block statistic section 61₂ transmits the calculated sub-region information S(l) to the block statistic section 61₁, and receives the sub-region information S(r) transmitted from the block statistic section 61₁.

In this way, the block statistic section 61₁ and the block statistic section 61₂ can acquire the sub-region information S(l) and S(r) calculated from an input image.

Then, the block statistic section 61 supplies the acquired sub-region information S(l) and S(r) to the BL strength determination section 62.

The BL strength determination section 62 generates backlight data BL for controlling the brightness of the backlight 43a when outputting the half images, based on the sub-region information S(l) and S(r) from the block statistic section 61, and supplies it to the BL control section 63 and the diffused light amount calculation section 64.

That is, for example, the BL strength determination section 62₁ generates backlight data BL_{R} when outputting the half image R, based on the sub-region information S(l) and S(r) from the block statistic section 61₁, and supplies it to the BL control section 63₁ and the diffused light amount calculation section 64₁.

Further, for example, the BL strength determination section 62₂ generates backlight data BL_{L} when outputting the half image L, based on the sub-region information S(l) and S(r) from the block statistic section 61₂, and supplies it to the BL control section 63₂ and the diffused light amount calculation section 64₂.

The BL control section 63 controls the brightness of the LEDs used when outputting the half image, from among the plurality of LEDs constituting the backlight 43a, based on the backlight data BL from the BL strength determination section 62.

That is, for example, the BL control section 63₁ controls the brightness of the LEDs arranged on the right side (the LEDs used when outputting the half image R), from among the plurality of LEDs constituting the backlight 43a, based on the backlight data BL_{R} from the BL strength determination section 62₁.

Further, for example, the BL control section 63₂ controls the brightness of the LEDs arranged on the left side (the LEDs used when outputting the half image L), from among the plurality of LEDs constituting the backlight 43a, based on the backlight data BL_{L} from the BL strength determination section 62₂.

The diffused light amount calculation section 64 calculates (calculates) the extent of the diffusion of light from each of the LEDs constituting the backlight 43a, based on the backlight data BL from the BL strength determination section 62, and supplies this calculation result to the correction section 65.

Namely, for example, the diffused light amount calculation section 64₁ calculates (calculates) the extent of the diffusion of light from the backlight 43a at the time when outputting the half image R, based on the backlight data BL_{R} from the BL strength determination section 62₁,and supplies this calculation result to the correction section 65₁.

Further, for example, the diffused light amount calculation section 64₂ calculates (calculates) the extent of the diffusion of light from the backlight 43a at the time when outputting the half image L, based on the backlight data BL_{L} from the BL strength determination section 62₂, and supplies this calculation result to the correction section 65₂.

A half image the same as that supplied to the block statistic section 61 is supplied from the partitioning section 41, by delaying from the timing at which the half image is supplied to the block statistic section 61, to the correction section 65.

The correction section 65 corrects the half image supplied from the partitioning section 41 into liquid crystal signals for this half image, based on the calculation result from the diffused light amount calculation section 64. Note that, liquid crystal signals for a half image represent signals for controlling the transmissivity of the liquid crystal panel 43b changed when outputting the half image.

Then, the correction section 65 controls the transmissivity of the liquid crystal panel 43b, by supplying the liquid crystal signals for the half image obtained by correction to the liquid crystal panel 43b, and causes the half image to be output as transmitted light, by causing light from the backlight 43a to be transmitted with the transmissivity after being controlled.

That is, for example, the correction section 65₁ corrects the half image R supplied from the partitioning section 41 into liquid crystal signals P_{R} for the half image R, based on the calculation result from the diffused light amount calculation section 64₁. Then, the correction section 65₁ controls the transmissivity of the liquid crystal panel 43b, by supplying the liquid crystal signals P_{R} for the half image R to the liquid crystal panel 43b, and causes the half image R to be output as transmitted light, by causing light from the backlight 43a to be transmitted with the transmissivity after being controlled.

Further, for example, the correction section 65₂ corrects the half image L supplied from the partitioning section 41 into liquid crystal signals P_{L} for the half image L, based on the calculation result from the diffused light amount calculation section 64₂. Then, the correction section 65₂ controls the transmissivity of the liquid crystal panel 43b, by supplying the liquid crystal signals P_{L} for the half image L to the liquid crystal panel 43b, and causes the half image L to be output as transmitted light, by causing light from the backlight 43a to be transmitted with the transmissivity after being controlled.

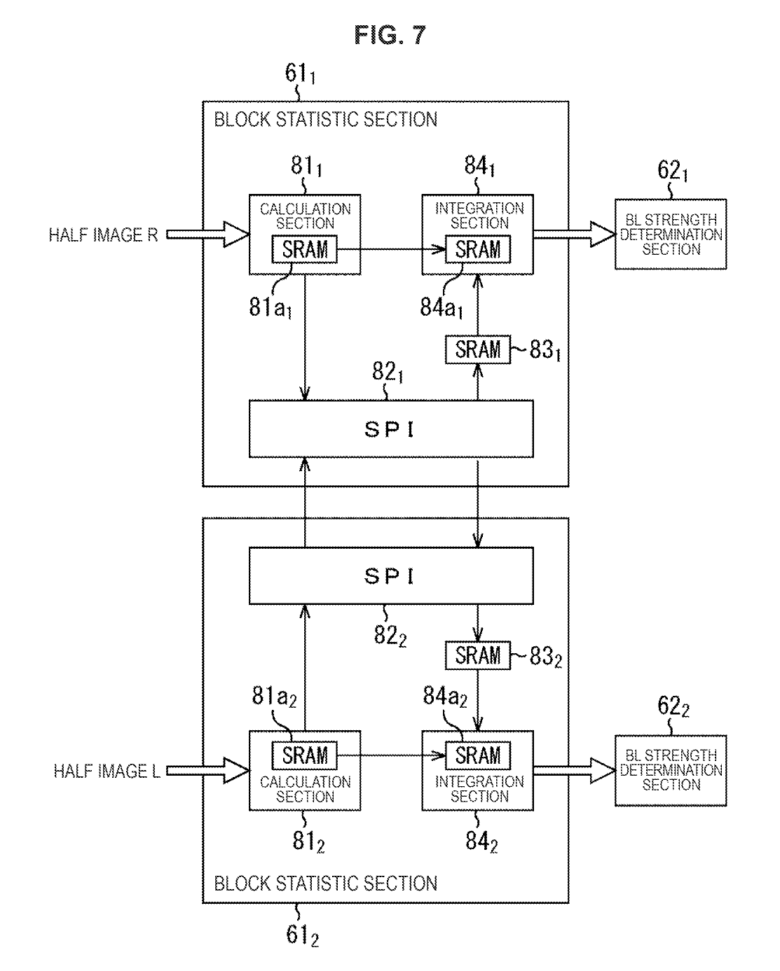

Next, FIG. 7 shows a detailed configuration example of the block statistic sections 61₁ and 61₂.

The block statistic section 61₁ is constituted from a calculation section 81₁ in which an SRAM 81a₁ is built-in, a Serial Parallel Interface (SPI) 82₁, an SRAM 83₁, and an integration section 84₁ in which an SRAM 84a₁ is built-in.

Further, similar to the block statistic section 61₁, the block statistic section 61₂ is constituted from a calculation section 81₂ in which an SRAM 81a₂ is built-in, an SPI 82₂, an SRAM 83₂, and an integration section 84₂ in which an SRAM 84a₂ is built-in.

The calculation section 81₁ performs blocking, for example, which divides the half image R from the partitioning section 41 into each of 6×6 (=36) sub-regions r₁ through to r₃₆.

Then, the calculation section 81₁ calculates respective sub-region information S(r₁) through to S(r₃₆) from each of the sub-regions r₁ through to r₃₆ obtained by this blocking, and causes it to be supplied to and held in the built-in SRAM 81a₁.

Further, the calculation section 81₁ reads sub-region information S(r₁) through to S(r₃₆) from the SRAM 81a₁, and supplies it to the SPI 82₁ and the integration section 84₁.

Note that, the calculation section 81₂ of the block statistic section 61₂ performs processes similar to those of the calculation section 81₁, reads sub-region information S(k₁) through to S(l₃₆) from the built-in SRAM 81a₂, and supplies it to the SPI 82₂ and the integration section 84₂.

The SPI 82₁ transmits the sub-region information S(r₁) through to S(r₃₆) from the calculation section 81₁ to the SPI 82₂, receives the sub-region information S(l₁) through to S(l₃₆) from the SPI 82₂, and causes it to be supplied to and held in the SRAM 83₁.

Note that, similar to the SPI 82₁, the SPI 82₂ of the block statistic section 61₂ transmits the sub-region information S(l₁) through to S(l₃₆) from the calculation section 81₂ to the SPI 82₁, receives the sub-region information S(r₁) through to S(r₃₆) from the SPI 82₁, and causes it to be supplied to and held in the SRAM 83₂.

The SRAM 83₁ holds the sub-region information S(l₁) through to S(l₃₆) from the SPI 81₁, and outputs the held sub-region information S(l₁) through to S(l₃₆) to the integration section 84₁, in accordance with a reading instruction from the integration section 84₁.

Note that, similar to the SRAM 83₁, the SRAM 83₂ of the block statistic section 61₂ holds the sub-region information S(r₁) through to S(r₃₆) from the SPI 81₂, and outputs the held sub-region information S(r₁) through to S(r₃₆) to the integration section 84₂, in accordance with a reading instruction from the integration section 84₂.

The integration section 84₁ causes the sub-region information S(r₁) through to S(r₃₆) from the calculation section 81₁ to be supplied to and held in the built-in SRAM 84a₁. Further, the integration section 84₁ reads the sub-region information S(l₁) through to S(l₃₆) held in the SRAM 83₁, and causes it to be supplied to and held in the built-in SRAM 84a₁.

Then, the integration section 84₁ supplies the sub-region information S(r₁) through to S(r₃₆) and S(l₁) through to S(l₃₆) held in the built-in SRAM 84a₁ to the BL strength determination section 62₁, as sub-region information calculated from the input image.

Incidentally, the integration section 84₁ may also calculate entire region information, which includes a maximum luminance, average luminance, distribution of luminance or the like within the entire region constituting the input image, based on the sub-region information S(r₁) through to S(r₃₆) and S(l₁) through to S(l₃₆), and may supply it to the BL strength determination section 62₁.

In this case, in addition to the sub-region information S(r₁) through to S(r₃₆) and S(l₁) through to S(l₃₆) from the integration section 84₁, the BL strength determination section 62₁ calculates backlight data for the half image R, based on the entire region information.

Note that, similar to the integration section 84₁, the integration section 84₂ of the block statistic section 61₂ supplies the sub-region information S(r₁) through to S(r₃₆) and S(l₁) through to S(l₃₆) held in the built-in SRAM 84a₂ to the BL strength determination section 62₂, as sub-region information calculated from the input image.

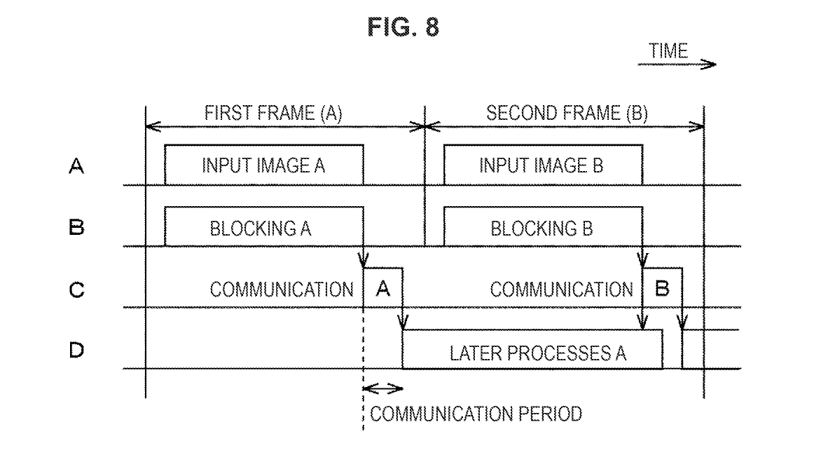

Next, FIG. 8 shows an example of the timing of processes performed by the block statistic section 61₁ and the block statistic section 61₂.

For example, as shown in the left side A of FIG. 8, when an input image A of a first frame is input to the partitioning section 41 of the television receiver 21, the partitioning section 41 partitions the input image A into a half image R and a half image L.

Further, the partitioning section 41 supplies the half image R obtained by partitioning to the block statistic section 61₁, and the half image L obtained by the same partitioning to the block statistic section 61₂.

Then, as shown in the left side B of FIG. 8, the block statistic sections 61₁ and 61₂ block the input image A into each of the sub-regions r₁ through to r₃₆ and through to l₃₆. Then, the block statistic sections 61₁ and 61₂ calculate sub-region information S(r₁) through to S(r₃₆) and S(l₁) through to S(l₃₆) from each of the sub-regions r₁ through to r₃₆ and l₁ through to l₃₆ obtained by this blocking.

That is, the block statistic section 61₁ blocks the half image R, and calculates sub-region information S(r₁) through to S(r₃₆) from each of the sub-regions r₁ through to r₃₆ obtained by this blocking.

Further, similarly, the block statistic section 61₂ blocks the half image L, and calculates sub-region information S(l₁) through to S(l₃₆) from each of the sub-regions lₗ through to l₃₆ obtained by this blocking.

Then, in a communication period such as shown in the left side C of FIG. 8, the block statistic section 61₁ and the block statistic section 61₂ mutually perform communication for acquiring each other's sub-region information. In this way, the block statistic section 61₁ and the block statistic section 61₂ acquire the sub-region information S(r₁) through to S(r₃₆) and S(l₁) through to S(l₃₆) calculated from the input image A.

Note that, for example, this communication is performed within a vertical blanking period from displaying an input image up to displaying the next input image.

Further, after the end of the communication shown in the left side C of FIG. 8, the block statistic section 61₁ supplies the sub-region information calculated from the input image to the BL strength determination section 62₁, and the block statistic section 61₂ supplies the sub-region information calculated from the input image to the BL strength determination section 62₂.

Then, after the end of the vertical blanking period, the processes by the BL strength determination section 62₁ through to the correction section 65₁ of the LSI 42₁, and the processes by the BL strength determination section 62₂ through to the correction section 65₂ of the LSI 42₁, are performed as later processes A shown in the right side D of FIG. 8, and an input image A is displayed.

Further, as shown in the right side A of FIG. 8, when an input image B of a second frame is input to the partitioning section 41 of the television receiver 21, processes the same as the time when the input image A of the first frame is input are performed, and similar processes are repeated for input images of a third frame onwards.

That is, processes, such as blocking shown in the right side B of FIG. 8 and communication shown in the right side C of FIG. 8, are performed for the input image B.

### (Operation Description of the Television Receiver 21)

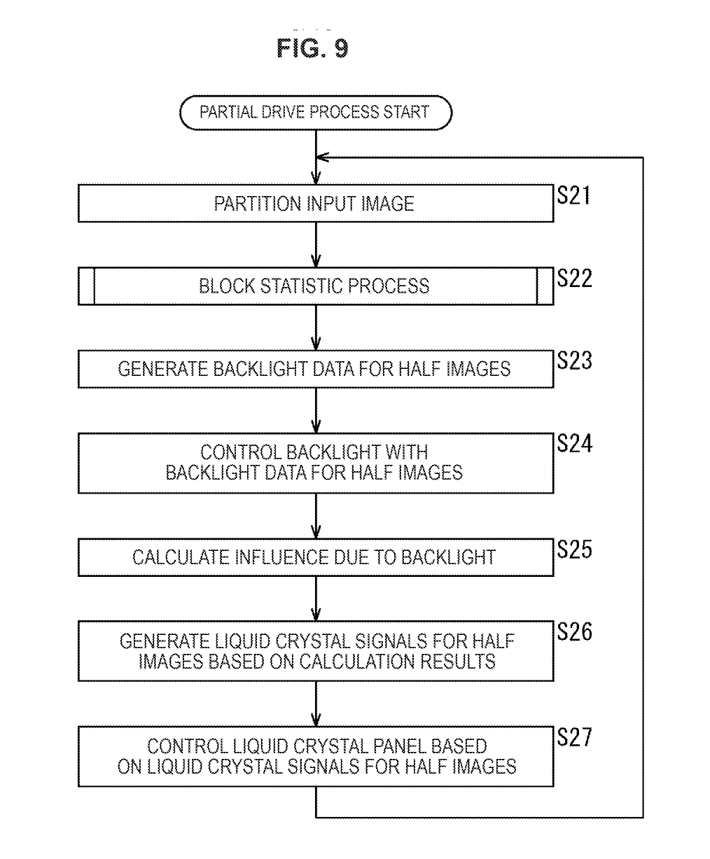

Next, a partial drive process performed by the television receiver 21 will be described with reference to the flow chart of FIG. 9.

This partial drive process is started, for example, at the time when a power supply of the television receiver 21 is turned on. At this time, an input image received by an antenna or the like, which is not illustrated, is input to the partitioning section 41 of the television receiver 21.

In step S21, the partitioning section 41 partitions the input image input to here into a half image R and a half image L, for example, and respectively supplies the half image R to the block statistic section 61₁ of the LSI 42₁, and the half image L to the block statistic section 61₂ of the LSI 42₂.

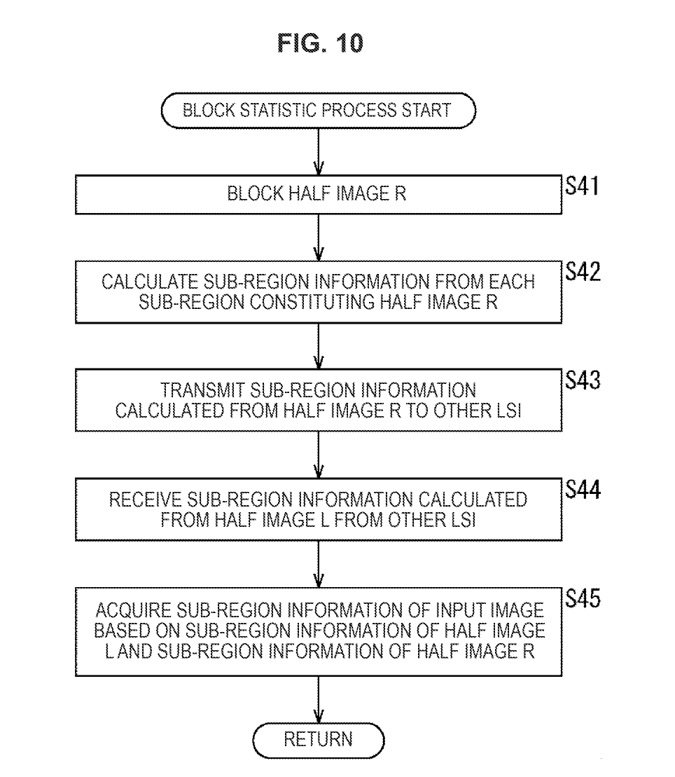

In step S22, the block statistic section 61₁ performs a block statistic process which acquires sub-region information S(r) and S(l) calculated from the input image, by integrating sub-region information S(r) calculated from the half image R and sub-region information S(l) calculated from the half image L. The details of this block statistic process will be described in detail with reference to the flow chart of FIG. 10.

Further, in step S22, the block statistic section 61₂ performs a block statistic process similar to that of the block statistic section 61₁.

In step S23, the BL strength determination section 62 generates backlight data BL for controlling the brightness of the backlight when outputting the half images, based on the sub-region information S(l) and S(r) from the block statistic section 61, and supplies it to the BL control section 63 and the diffused light amount calculation section 64.

In step S24, the BL control section 63 controls the brightness of the LEDs to emit light when outputting the half image, from among the plurality of LEDs constituting the backlight 43a, based on the backlight data BL from the BL strength determination section 62.

In step S25, the diffused light amount calculation section 64 calculates (calculates) the extent of the diffusion of light from the backlight 43a, based on the backlight data BL from the BL strength determination section 62, and supplies this calculation result to the correction section 65.

In step S26, the correction section 65 generates liquid crystal signals for the half image, by correcting the half image supplied from the partitioning section 41, based on the calculation result from the diffused light amount calculation section 64.

In step S27, the correction section 65 controls the transmissivity of the liquid crystal panel 43b, by supplying the liquid crystal signals for the half image obtained by correction to the liquid crystal panel 43b, and causes the half image to be output as transmitted light, by causing light from the backlight 43a to be transmitted with the transmissivity after being controlled.

Then, when a new input image is supplied to the partitioning section 41, the process returns to step S21, and processes similar to those onwards are performed. Note that, this partial drive process ends at the time when the power supply of the television receiver 21 is turned off or the like.

### (Details of the Block Statistic Process)

Next, the details of the block statistic process in step S22 of FIG. 9 will be described with reference to the flow chart of FIG. 10.

Note that, the block statistic section 61₁ and block statistic section 61, respectively perform a similar block statistic process. Therefore, in FIG. 10, a description will be made only for the block statistic process performed by the block statistic section 61₁, and a description of the block statistic process performed by the block statistic section 61₂ will be omitted.

In step S41, the calculation section 81₁ of the block statistic section 61₁ blocks the half image R from the partitioning section 41, and divides it, for example, into each of 6×6 (=36) sub-regions r₁ through to r₃₆.

In step S42, the calculation section 81₁ calculates respective sub-region information S(r₁) through to S(r₃₆) from each of the sub-regions r₁ through to r₃₆ obtained by this blocking, and causes it to be supplied to and held in the built-in SRAM 81a₁.

Further, the calculation section 81₁ reads sub-region information S(r₁) through to S(r₃₆) from the built-in SRAM 81a₁, and supplies it to the SPI 82₁ and the integration section 84₁.

In step S43, the SPI 82₁ of the block statistic section 61₁ transmits sub-region information S(r₁) through to S(r₃₆) from the calculation section 81₁ to the SPI 822 of the other block statistic section 61₂.

In step S44, the SPI 82₁ of the block statistic section 61₁ receives the sub-region information S(l₁) through to S(l₃₆) from the SPI 82₂ of the other block statistic section 61₂, and causes it to be supplied to and held in the SRAM 83₁.

In step S45, the integration section 84₁ of the block statistic section 61₁ causes the sub-region information S(r₁) through to S(r₃₆) from the calculation section 81₁ to be supplied to and held in the built-in SRAM 84a₁. Further, the integration section 84₁ reads the sub-region information S(l₁) through to S(l₃₆) held in the SRAM 83₁, and causes it to be supplied to and held in the built-in SRAM 84a₁.

Then, the integration section 84₁ acquires the sub-region information S(r₁) through to S(r₃₆) and S(l₁) through to S(l₃₆) held in the built-in SRAM 84a₁ as sub-region information calculated from the input image, supplies it to the BL strength determination section 62₁, and this process returns to step S22 of FIG. 9.

As described above, according to the partial drive process of FIG. 9, since the processes are caused to be distributed by using the 2 LSI 42₁ and LSI 42₂, the load applied to the 1 LSI 42₁ (or the LSI 42₂) can be reduced.

Accordingly, the backlight 43a and the liquid crystal panel 43b can be promptly controlled, by using a small-sized LSI 42₁ and LSI 42₂, even at the time when the size of an input image is large.

Further, since it may not be necessary to use a large-sized LSI with a comparatively high cost, the manufacturing cost of the television receiver 21 can be reduced. In addition, since it may not be necessary to include a large space in order for a large-sized LSI to be built-in, at the time of manufacturing the television receiver 21, the television receiver 21 can be more easily manufactured, when compared to the case of manufacturing a television receiver in which a large-sized LSI is built-in.

Next, the case where the microcomputer 44 changes the state of the registers of the LSI 42₁ and LSI 42₂ will be described with reference to FIG. 11 and FIG. 12.

Next, FIG. 11 shows an example at the time when the microcomputer 44 changes the state of respective registers, by individually controlling the LSI 42₁ and the LSI 42₂.

A state is shown in A of FIG. 11 in which the microcomputer 44 causes the state of respective registers to change from a state A to a state B, by individually controlling the LSI 42₁ and the LSI 42₂.

A state is shown in the upper side B of FIG. 11 in which the LSI 42₁ changes a state A of the register to a state B, with a timing at which a third rising edge from the left occurs, in a vertical synchronization signal.

Further, a state is shown in the lower side B of FIG. 11 in which the LSI 42₂ changes a state A of the register to a state B, with a timing at which a second rising edge from the left occurs, in a vertical synchronization signal.

Note that, for example, the vertical synchronization signal is supplied from the microcomputer 44 to the LSI 42₁ and the LSI 42₂.

For example, in the case where the microcomputer 44 supplies register changing information to the LSI 42₂, directly before a second rising edge from the left occurs, the LSI 42₂ changes a state A of the register to a state B, by synchronizing the timing at which the second rising edge from the left occurs, such as shown in the lower side B of FIG. 11.

Here, for example, register changing information is called information for causing a state A of a register to change to a state B.

Further, for example, in the case where the microcomputer 44 supplies register changing information to the LSI 42₁, directly after a second rising edge from the left occurs, the LSI 42₁ changes a state A of the register to a state B, by synchronizing the timing at which the third rising edge from the left occurs, such as shown in the upper side B of FIG. 11.

This is generally due to changing the state of the register, with a timing at which a rising edge occurs, in the vertical synchronization signal, by the LSI 42₁ and the LSI 42₂.

In the case where the microcomputer 44 causes the register to change, by individually supplying the register changing information to the LSI 42₁ and the LSI 42₂, the state of the registers of the LSI 42₁ and the LSI 42₂ not being able to change with a same timing can occur, such as shown in the upper side B of FIG. 11 and the lower side B of FIG. 11.

Here, for example, the microcomputer 44 supplies the register changing information to only the 1 LSI 42₁, and the LSI 42₁ transmits the register changing information from the microcomputer 44, along with the sub-region information S(r₁) through to S(r₃₆) calculated from the half image R, to the LSI 42₂.

Also, it is desirable for the LSI 42₁ and the LSI 42₂ to synchronize the timing at which changes are reflected based on the register changing information, when performing the next communication.

Next, FIG. 12 shows an example at the time when the microcomputer 44 changes the state of the registers of the 2 LSI 42₁ and LSI 42₂, by supplying the register changing information to only the 1 LSI 42₁.

A state is shown in A of FIG. 12 in which the microcomputer 44 supplies the register changing information to only the LSI 42₁, and the LSI 42₁ transmits the register changing information from the microcomputer 44 to the LSI 42₂.

A state is shown in B of FIG. 12 in which the LSI 42₁ which has acquired the register changing information from the microcomputer 44, and the LSI 42, which has received the register changing information from the LSI 42₁, change a state C of the register to a state D, by reflecting the register changing information with a same timing.

For example, the LSI 42₁ transmits the register changing information from the microcomputer 44, along with the sub-region information, to the LSI 42₂.

Then, the LSI 42₁ and the LSI 42₂ reflect the register changing information, with a timing synchronized by respective communication between the LSI 42₁ and LSI 42₂ (a timing at which a second rising edge from the left occurs).

As shown in B of FIG. 12, by taking the synchronization of a timing at which the register changing information is reflected, by communication performed between the LSI 42₁ and the LSI 42₂, it becomes possible for the LSI 42₁ and the LSI 42₂ to change the registers with a same timing.

Further, in the present embodiment, while the 2 LSI 42₁ and LSI 42₂ are included in the television receiver 21, 3 or more LSI can be included.

Next, FIG. 13 shows an example at the time when including the 4 LSI 42a through to 42d in the television receiver 21.

Note that, only the LSI 42a through to 42d included in the television receiver 21 are illustrated in FIG. 13, and illustrations of the other blocks are omitted.

For example, as shown in FIG. 13, in the case were the 4 LSI 42a through to 42d are included, the partitioning section 41 divides an input image into 4, for example, and respectively supplies the 4 ¼ images obtained as a result of this to the LSI 42a through to 42d.

The LSI 42a performs processes similar to those of the above described LSI 42₁ and LSI 42₂, targeting the supplied ¼ images, and calculates sub-region information a from the ¼ images. Further, similarly, the LSI 42b, LSI 42c and LSI 42d respectively calculate sub-region information b, c and d.

Then, as shown in FIG. 13, in first time communication performed between the LSI 42a through to 42d, the LSI 42a transmits the sub-region information a to the LSI 42b, and receives the sub-region information b from the LSI 42b.

Further, in the first time communication, the LSI 42c transmits the sub-region information c to the LSI 42d, and receives the sub-region information d from the LSI 42d.

In this way, after the end of the first time communication, the LSI 42a and the LSI 42b hold the sub-region information a and b, and the LSI 42c and the LSI 42d hold the sub-region information c and d.

Further, as shown in FIG. 13, in second time communication performed between the LSI 42a through to 42d, the LSI 42a transmits the sub-region information a and b to the LSI 42c, and receives the sub-region information c and d from the LSI 42c.

Further, in the second time communication, the LSI 42b transmits the sub-region information a and b to the LSI 42d, and receives the sub-region information c and d from the LSI 42d.

In this way, after the end of the second time communication, the LSI 42a through to 42d each hold the sub-region information a through to d.

Note that, in FIG. 13, in the first time communication, the LSI 42a and the LSI 42b communicate, and the LSI 42c and the LSI 42d communicate. Further, in the second time communication, the LSI 42a and the LSI 42c communicate, and the LSI 42b and the LSI 42d communicate.

However, it is not limited to the frequency or order of communication, the combination of communicating LSI or the like. That is, for example, in the first time communication, the LSI 42a and the LSI 42c may communicate and the LSI 42b and the LSI 42d may communicate, and in the second time communication, the LSI 42a and the LSI 42b may communicate, and the LSI 42c and the LSI 42d may communicate.

Further, for example, the number of LSI is not limited to 4, and a configuration in which the number of LSI is made to be 8 (=2³) can be adopted, if performing third time communication. In addition, for example, similarly, the number of LSI can be made to be 16 (=2⁴), if performing fourth time communication.

That is, a configuration in which the number of LSI is made to be 2^{N} can be adopted, if performing N time communication.

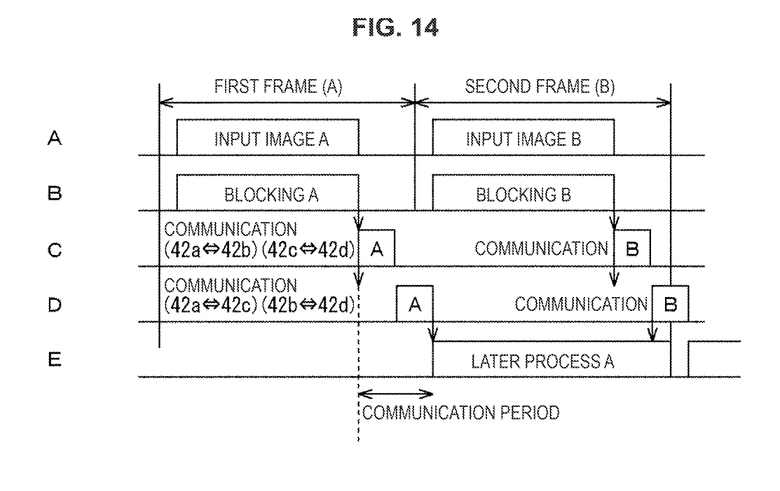

Next, FIG. 14 shows an example of the timing of processes performed by the LSI 42a through to 42d of FIG. 13.

For example, as shown in the left side A of FIG. 14, when an input image A of a first frame is input to the partitioning section 41 of the television receiver 21, the partitioning section 41 partitions the input image A into 4 ¼ images.

Further, the partitioning section 41 respectively supplies the 4 ¼ images obtained by partitioning to the LSI 42a through to 42d.

Then, as shown in the left side B of FIG. 14, the LSI 42a through to 42d respectively block the ¼ images into each of the sub-regions. Then, the LSI 42a through to 42d calculate sub-region information from each of the sub-regions obtained by this blocking.

Afterwards, in a communication period such as shown in the left side C of FIG. 14, first time communication shown in FIG. 13 is performed between the LSI 42a through to 42b. Further, in a communication period such as shown in the left side D of FIG. 14, second time communication shown in FIG. 13 is performed between the LSI 42a through to 42d.

In this way, the LSI 42a through to 42d each hold the sub-region information a through to d the same as the sub-region information calculated from the input image.

As shown in E of FIG. 14, the LSI 42a through to 42d respectively perform later processes A using the held sub-region information a through to d, after the end of the second time communication.

Note that, processes the same as those of the input image A of the first frame are also performed for an input image B of a second frame, and from here onwards, the same processes are repeated.

### 2. MODIFIED EXAMPLE

In the present embodiment, while the television receiver 21 including the LSI 42₁ and the LSI 42₂ is described, other than this, for example, the present disclosure can also be applied to an imaging apparatus including the LSI 42₁ and the LSI 42₂. That is, an electronic device including a plurality of LSI is not limited to the television receiver 21.

Further, in the present embodiment, for example, while the LSI 42₁ controls the display of the half image R, and the LSI 42₂ controls the display of the half image L, other than this, for example, the processes performed by the LSI 42₁ and the LSI 42₂ are not limited to this.

That is, for example, if there are processes performed by including all information obtained from an input image, the LSI 42₁ and the LSI 42₂ can also perform such processes. Further, the processing target is also not limited to an input image, and audio signals can be made a processing target.

Specifically, for example, in the case where the LSI 42₁ and the LSI 42₂ are included in an imaging apparatus having an imaging element, the LSI 42₁ and the LSI 42₂ can perform, for example, a camera shake correction process or the like which reduces camera shake or the like occurring in an input image, in accordance with the movement of each region constituting the input image from the imaging element.

Specifically, for example, the LSI 42₁ detects a movement vector mv(R) of each region constituting the half image R, and the LSI 42₂ detects a movement vector mv(L) of each region constituting the half image L. Then, the LSI 42₁ transmits the movement vector mv(R) detected from the half image R to the LSI 42₂, and receives the movement vector mv(L) from the LSI 42₂.

In this way, the LSI 42₁ and the LSI 42₂ each acquire the movement vectors mv(R) and mv(L) the same as the movement vectors of each region constituting the input image.

The LSI 42₁ corrects camera shake or the like occurring in the half image R, based on the acquired movement vectors mv(R) and mv(L), and the LSI 42₂ corrects camera shake or the like occurring in the half image L, based on the acquired movement vectors mv(R) and mv(L).

Note that, in an imaging apparatus such as a camera, the half image R and the half image L after camera shake correction are set to 1 image, that is, an input image after camera shake correction, and it is held, for example, in a memory or the like within the imaging apparatus.

Additionally, the present technology may also be configured as below.

(1)

A signal processing device, including:

a partitioning section which partitions input data into a plurality of different partitioned data; and

a plurality of signal processing sections which respectively process the plurality of different partitioned data,

wherein the signal processing sections each have
a first processing section which performs a first data process targeting the partitioned data, and
a communication section which transmits a first processing result by the first processing section to another of the signal processing sections, and receives a second processing result transmitted from another of the signal processing sections.
   (2)

The signal processing device according to (1),

wherein the signal processing sections each additionally have
an acquisition section which acquires a third processing result obtained at a time when applying the first data process to the input data based on the first processing result and the second processing result, and
a second processing section which performs a second data process different to the first data process, the second data process targeting the third processing result acquired by the acquisition section.
   (3)

The signal processing device according to (1) or (2),
wherein the communication section also transmits, to another of the signal processing sections, setting information showing setting contents to be reflected in the plurality of signal processing sections in addition to the first processing result.
   (4)

The signal processing device according to (3),

wherein the communication section causes a timing at which setting contents are reflected based on the setting information to be synchronized with another of the signal processing sections which has received the setting information.

(5)

The signal processing device according to (1) to (4),

wherein the communication section transmits the first processing result, along with the second processing result received from another of the signal processing sections, to an additional another of the signal processing sections.

(6)

The signal processing device according to (2),

wherein the partitioning section partitions an input image input as the input data into a plurality of different partial images, and

wherein, in each of the signal processing sections,
the first processing section performs the first data process which calculates sub-region information, which is information related to a luminance of sub-regions obtained by dividing the partial images, targeting the partial images,
the communication section transmits first sub-region information obtained as a processing result of the first processing section to another of the signal processing sections, and receives calculated second sub-region information targeting another of the partial images from another of the signal processing sections,
the acquisition section acquires the first sub-region information calculated by the first processing section and the second sub-region information received by the communication section as third sub-region information obtained at the time when applying the first data process to the input image, and
the second processing section performs the second process which performs lighting for a display of the partial images, and generates backlight data for controlling a part of a backlight, targeting the third sub-region information acquired by the acquisition section.
   (7)

A signal processing method of a signal processing device including a partitioning section and a plurality of signal processing sections, the method including:

by the partitioning section,
a partitioning step which partitions input data into a plurality of different partitioned data, and

by each of the signal processing sections,
a first processing step which performs a first data process targeting the partitioned data, and
a communication step which transmits a first processing result by the first processing step to another of the signal processing sections, and receives a second processing result transmitted from another of the signal processing sections.
   (8)

A program for causing a computer to function as:

a partitioning section which partitions input data into a plurality of different partitioned data; and

a plurality of signal processing sections which respectively process the plurality of different partitioned data,

wherein the signal processing sections each have
a first processing section which performs a first data process targeting the partitioned data, and
a communication section which transmits a first processing result by the first processing section to another of the signal processing sections, and receives a second processing result transmitted from another of the signal processing sections.

Incidentally, the above mentioned series of processes can, for example, be executed by hardware, or can be executed by software. In the case where the series of processes is executed by software, a program configuring this software is installed in a computer from a medium recording a program. Here, examples of the computer include a computer incorporated into specialized hardware, and a general-purpose personal computer which is capable of executing various functions by installing various programs.

### [Example of Computer Configuration]

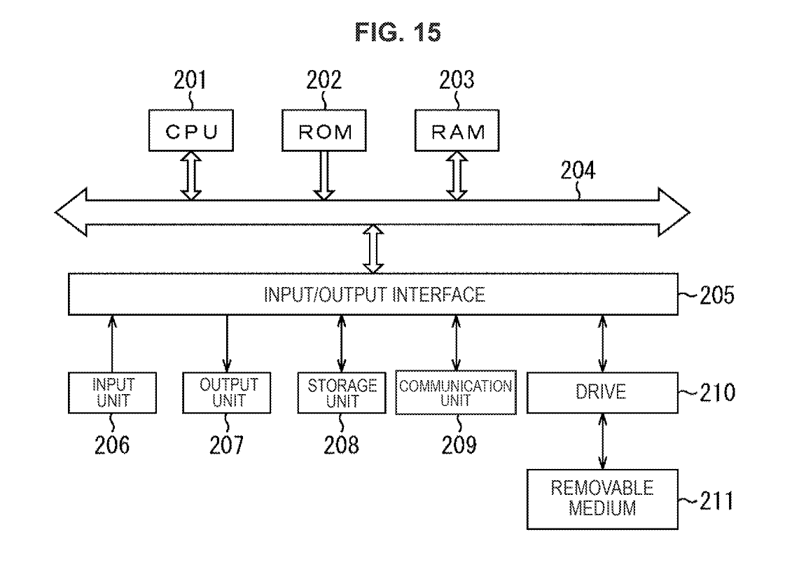

FIG. 15 shows a hardware configuration example of a computer that performs the above-described series of processing using a program.

A CPU (Central Processing Unit) 201 executes various processing according to programs stored in a ROM (Read Only Memory) 202 or a storage unit 208. The RAM (Random Access Memory) 203 appropriately stores the programs executed by the CPU 201, data, and the like. The CPU 201, the ROM 202, and the RAM 203 are connected to each other through a bus 204.

In addition, an input/output interface 205 is connected to the CPU 201 through the bus 204. An input unit 206 and output unit 207 are connected to the input/output interface 205, the input unit 206 including a keyboard, a mouse, a microphone, and the like, the output unit 207 including a display, a speaker, and the like. The CPU 201 executes various processing in accordance with respective instructions input from the input unit 206. Then, the CPU 201 outputs the processing result to the output unit 207.

The storage unit 208 connected to the input/output interface 205 includes, for example, a hard disk, and stores the programs to be executed by the CPU 201 and various data. A communication unit 209 communicates with an external apparatus through a network such as the Internet or a local area network.

In addition, programs may be acquired through the communication unit 209 and stored in the storage unit 208.

A drive 210 is connected to the input/output interface 205. When a removable medium 211 such as a magnetic disk, an optical disk, a magnetic-optical disk, or a semiconductor memory is loaded onto the drive 210, the drive 210 drives the removable medium 211 and acquires programs, data, and the like stored in the removable medium 211. The acquired programs and data are transferred to the storage unit 208 as necessary, and are stored in the storage unit 208.

The recording medium that records (stores) the program to be installed in the computer and made executable by the computer includes: the removable medium 211 which is a package medium including a magnetic disk (including a flexible disk), an optical disk (including a CD-ROM (Compact Disc-Read Only Memory), and a DVD (Digital Versatile Disc)), a magnetic-optical disk (including an MD (Mini-Disc)), a semiconductor memory, and the like; the ROM 202 that temporarily or permanently stores the programs; the hard disk forming the storage unit 208; and the like, as illustrated in FIG. 15. The program is recorded in the recording medium as necessary through the communication unit 209 which is an interface such as a router or a modem, by utilizing a wired or wireless communication medium such as a local area network, the Internet, or digital satellite broadcast.

In the present disclosure, steps of describing the above series of processes may include processing performed in time-series according to the description order and processing not processed in time-series but performed in parallel or individually.

Further, the disclosure is not limited to the embodiments described above, and various changes and modifications may be made without departing from the scope of the disclosure.

### REFERENCE SIGNS LIST

21 television receiver, 41 partitioning section, 42₁, 42₂, 42a through to 42d LSI, 43 display section, 43a backlight, 43b liquid crystal panel, 44 microcomputer, 45 operation section, 61₁, 61₂ block statistic section, 62₁, 62₂ BL strength determination section, 63₁, 63₂ BL control section, 64₁, 64₂ diffused light amount calculation section, 65₁, 65₂ correction section, 81₁, 81₂ calculation section, 81a₁, 81a₂ SRAM, 82₁, 82₂ SPI, 83₁, 83₂ SRAM, 84₁, 84₂ integration section, 81a₁, 81a₂ SRAM

1. A signal processing device, comprising:
a partitioning section which partitions input data into a plurality of different partitioned data; and
a plurality of signal processing sections which respectively process the plurality of different partitioned data,
wherein the signal processing sections each have
a first processing section which performs a first data process targeting the partitioned data, and
a communication section which transmits a first processing result by the first processing section to another of the signal processing sections, and receives a second processing result transmitted from another of the signal processing sections.

2. The signal processing device according to claim 1,
wherein the signal processing sections each additionally have
an acquisition section which acquires a third processing result obtained at a time when applying the first data process to the input data based on the first processing result and the second processing result, and
a second processing section which performs a second data process different to the first data process, the second data process targeting the third processing result acquired by the acquisition section.

3. The signal processing device according to claim 2,
wherein the communication section also transmits, to another of the signal processing sections, setting information showing setting contents to be reflected in the plurality of signal processing sections in addition to the first processing result.

4. The signal processing device according to claim 3,
wherein the communication section causes a timing at which setting contents are reflected based on the setting information to be synchronized with another of the signal processing sections which has received the setting information.

5. The signal processing device according to claim 4,
wherein the communication section transmits the first processing result, along with the second processing result received from another of the signal processing sections, to an additional another of the signal processing sections.

6. The signal processing device according to claim 2,
wherein the partitioning section partitions an input image input as the input data into a plurality of different partial images, and
wherein, in each of the signal processing sections,
the first processing section performs the first data process which calculates sub-region information, which is information related to a luminance of sub-regions obtained by dividing the partial images, targeting the partial images,
the communication section transmits first sub-region information obtained as a processing result of the first processing section to another of the signal processing sections, and receives calculated second sub-region information targeting another of the partial images from another of the signal processing sections,
the acquisition section acquires the first sub-region information calculated by the first processing section and the second sub-region information received by the communication section as third sub-region information obtained at the time when applying the first data process to the input image, and
the second processing section performs the second process which performs lighting for a display of the partial images, and generates backlight data for controlling a part of a backlight, targeting the third sub-region information acquired by the acquisition section.

7. A signal processing method of a signal processing device including a partitioning section and a plurality of signal processing sections, the method comprising:
by the partitioning section,
a partitioning step which partitions input data into a plurality of different partitioned data, and
by each of the signal processing sections,
a first processing step which performs a first data process targeting the partitioned data, and
a communication step which transmits a first processing result by the first processing step to another of the signal processing sections, and receives a second processing result transmitted from another of the signal processing sections.

8. A program for causing a computer to function as:
a partitioning section which partitions input data into a plurality of different partitioned data; and
a plurality of signal processing sections which respectively process the plurality of different partitioned data,
wherein the signal processing sections each have
a first processing section which performs a first data process targeting the partitioned data, and
a communication section which transmits a first processing result by the first processing section to another of the signal processing sections, and receives a second processing result transmitted from another of the signal processing sections.
